(19) United States
(12) Patent Application Publication
(10) Pub. No.: US 2018/0169883 A1
(43) Pub. Date: Jun. 21, 2018

(54) DEVICE FOR CHOPPING FOOD

(71) Applicant: Genius GmbH, Limburg (DE)

(72) Inventor: Cedomir REPAC, Brechen (DE)

(21) Appl. No.: 15/735,187

(22) PCT Filed: Jun. 10, 2016
(86) PCT No.: PCT/EP2016/063283

§ 371 Date: Dec. 10, 2017

(30) Foreign Application Priority Data
Jun. 12, 2015 (DE) 10 2015 109 402.9

(51) Int. Cl. B26D 3/26; B26D 3/11; B26D 3/28; B26D 7/06

(52) U.S. Cl. CPC B26D 3/26; B26D 3/11; B26D 2007/0018; B26D 7/0666; B26D 2210/02; B26D 3/283

(57) ABSTRACT

The invention relates to a device for chopping food, having a base part which has a receptacle for a cutting part, and having an actuating part which is fixable to the base part in an articulated manner such that the actuating part is pivotable toward the cutting part in order to push through an item to be chopped. The device is distinguished in that the actuating part is pivotable toward the cutting part in order to push through an item to be chopped, characterized in that the device has at least one chopping tool in the manner of a sharpener.

### CROSS-REFERENCE TO RELATED APPLICATIONS

The present application is the U.S. national phase of International Application No. PCT/EP2016/063283 filed Jun. 10, 2016, which claims priority of German Application No. 10 2015 109 402.9 filed Jun. 12, 2015, the entire disclosure of which is incorporated herein by reference.

### FIELD OF THE INVENTION

The invention relates to a device for chopping food, having a base part which has a receptacle for a cutting part, and having an actuating part which is fixable to the base part in an articulated manner such that the actuating part is pivotable toward the cutting part in order to push through an item to be chopped.

### BACKGROUND OF THE INVENTION

DE 10 2009 023 167 A1 has disclosed a device for cutting foodstuffs, such as fruit and vegetables, having a cutting part which has a plurality of cutting edges, and having an actuating part, said cutting part and actuating part being mounted so as to be pivotable relative to each other. In order to cut the item for cutting, the actuating part is pushed toward the cutting part, wherein the actuating part has a plunger which pushes the item for cutting through the cutting part, wherein the cutting edges protrude into corresponding depressions of the plunger. The cutting part has a cutting frame in which cutting blades are held. The device furthermore has a cover part for mounting on a receiving container for the cut item for cutting, wherein the cover part has an opening which forms a passage for the cut item for cutting.

DE 20 2011 050 041 U1 has disclosed a cutting insert with a first cutting blade arrangement for a food chopping device which has a pressing plunger for pushing an item to be chopped through the cutting insert. The cutting insert is distinguished in that the first cutting blade arrangement is arranged in a first region of the cutting insert, and in that a second region, which is different from the first region, has a second cutting blade arrangement.

DE 21 2005 000 048 U1 has disclosed a food processing device having a container with a bottom and a plurality of upwardly extending side walls, wherein the side walls have an upper end and a bottom end, and wherein the container has an upper end and a bottom end, and having a tray which is fastened to the container closer to the upper end of the container than to the bottom end of the container, wherein the tray defines an inner region within an area which is defined by the side walls of the container, wherein the tray has a plurality of cutting edges. In addition, the food processing device has a cover which is mounted pivotably on the container, wherein the cover has a plurality of projections which, in terms of their size and shape, are configured in such a manner that they are received between the plurality of cutting edges when the cover is closed.

By means of the use of different cutting parts having different blade arrangements, the item of food to be chopped can be split into differently sized slices or sticks.

### SUMMARY OF THE INVENTION

It is the object of the present invention to indicate a device for chopping food of the type mentioned at the beginning which permits cutting the food to be chopped into a shape suitable for decorating dishes of food.

The object is achieved by a device for chopping food of the type mentioned at the beginning which is characterized in that the device has at least one chopping tool in the manner of a sharpener, wherein the chopping tool is insertable into the receptacle, or wherein there is a further base part which has the chopping tool and which is connectable instead of the base part to the actuating part in an articulated manner, or wherein the actuating part has the chopping tool.

The invention has the very particular advantage that food which is to be chopped, such as, for example, carrots, radishes or cucumbers, can be cut into spiral ribbons which are suitable in particular for decorating a meal, such as, for example, a prepared salad. As is explained in detail further below, the device according to the invention can advantageously be designed as a cover for a vessel or can itself have a vessel which collects the food chopped by being pushed through the cutting grid. After the chopping operation, it is possible in particular to leave the chopped food in the vessel and additionally with the aid of a chopping tool in the manner of a sharpener to produce spiral ribbons which are likewise collected in the vessel. A prepared dish consisting of, preferably different, chopped pieces of food, on which at the top the decorating spiral ribbons rest, is thereby produced in the vessel. In an advantageous manner, the decorated prepared food can also be served in the vessel, preferably after the chopping device has been removed.

In a particularly advantageous embodiment, the chopping tool is insertable in the manner of a sharpener, in particular instead of the cutting part, into the receptacle. Such an embodiment has the particular advantage that, after a chopping operation in which food is pressed through the cutting part with the aid of the actuating part, the user can rapidly and efficiently convert the device for producing spiral ribbons. In this connection, it can advantageously be provided that the chopping tool is insertable in an accurately fitting and/or latching manner into the receptacle. This ensures that the chopping tool is securely held in its working position.

The chopping tool can advantageously have a holding plate which, in terms of shape and size, has the same outer contour as the cutting part. The effect advantageously achieved by this is that the cutting part or the chopping tool can be selectively fixed in a secure and reliable manner in the receptacle of the base part without a relatively great effort and without additional fixing components being required.

In a particularly advantageous embodiment, the chopping tool has a holding plate into which at least one of a plurality of different cutting inserts is selectively fittable. In particular, it can advantageously be provided that each cutting insert has an, in particular conical, receiving space for the introduction of an item of food, on the wall of which receiving space a cutting blade is in each case arranged, and/or that each cutting insert in each case has an, in particular conical, receiving space for the introduction of an item of food, in which receiving space the item of food is rotatable. The cutting inserts can differ in particular in respect of their shape and/or size and/or in respect of the thickness and/or width of the spiral ribbons cuttable with them and/or in respect of the number of spiral ribbons arising simultaneously during a cutting operation.

In a particular embodiment, the device has an insert which is insertable, in particular in an accurately fitting and/or latching manner, into the receptacle and has both the cutting part and the chopping tool. Such an embodiment has the particular advantage that the device does not have to be converted if, after a chopping operation in which the cutting part has been used, spiral ribbons are subsequently intended to be cut; or conversely if, after the cutting of spiral ribbons, chopping is intended to take place using the cutting part.

In an entirely different embodiment, the actuating part has the chopping tool. The latter can be arranged in particular in such a manner that it is preferably used when the actuating part is closed, i.e. when the actuating part is pivoted toward the cutting part. If spiral ribbons are then cut with the aid of the chopping tool, said spiral ribbons can drop through the receptacle, into which no cutting part has been inserted for this cutting operation, into a vessel, for example. It is alternatively also possible for the base part to have a dedicated through opening for this purpose next to the receptacle. In such an embodiment, the cutting part can remain in the receptacle during the cutting of spiral ribbons.

The chopping tool can advantageously be constructed in such a manner that it has an, in particular conical, receiving space for the introduction of an item of food, such as, for example, a carrot, a radish, a cucumber or a zucchini, on the wall of which receiving space a cutting blade is arranged. Alternatively or in addition, it can also be provided that the chopping tool has an, in particular conical, receiving space for the introduction of an item of food, in which receiving space the item of food is rotatable. In addition, the wall of the receiving space has an opening through which the spiral ribbon can pass out of the receiving space.

The cutting blade is preferably arranged in such a manner that, during a rotational movement, similarly to the situation when sharpening a pencil, a spiral layer is severed in an encircling manner from the end side of the rotating food. For this purpose, the cutting edge of the cutting blade can be arranged in such a manner that it projects into the receiving space, wherein the parallel spacing of the cutting blade from the receiving space wall determines the thickness of the severed layer.

According to an independent concept of the invention with regard to the chopping tool in the form of a sharpener, which can also be realized independently of a device for chopping food having a base part and an actuating part, it is possible for layers of different thickness to be severed in a manner dependent on the direction of rotation. Such a device firstly has the very particular advantage that the user can decide individually whether he or she wishes to cut the item of food into thin or thick spiral ribbons. Secondly, such an embodiment has the very particular advantage that particularly brittle or sensitive food, in the case of which the ribbons tend to break if they are cut too thinly, can be alternatively cut into relatively thick spiral ribbons. Conversely, food which is unsuitable for cutting into thick spiral ribbons can be selectively cut into thin spiral ribbons. In short: such an embodiment makes it possible in particular to adapt the cutting thickness to the particular food.

In particular, it can advantageously be provided that the chopping tool severs a layer of a first thickness from an item of food rotating in the clockwise direction in the receiving space, and that the chopping tool severs a layer of a second thickness, which is different from the first thickness, from an item of food rotating counterclockwise in the receiving space.

The cutting into spiral ribbons of different layer thicknesses, in particular in a manner dependent on the direction of rotation, can be realized, for example, by the use of a pendulum blade which has two cutting edges. In this connection, it can be provided in particular that one cutting edge serves for cutting into thin spiral ribbons, while the other cutting edge serves for cutting in thick spiral ribbons.

In particular, the pendulum blade can be arranged, for example, in such a manner that, with regard to the first cutting edge, a first spacing from the wall of the receiving space arises in the case of a clockwise rotation of the item of food, whereas a second spacing of the second cutting edge from the receiving space arises in the case of a counterclockwise rotation of the item of food, wherein the first spacing differs from the second spacing. In particular, the cutting blades can be oriented parallel to one another and/or oppositely to one another with respect to the orientation of the cutting edges. In an advantageous embodiment, the pendulum blade is suspended in such a manner that, in the case of a clockwise rotation of the item of food, the first cutting edge automatically rotates into the receiving space, whereas the second cutting edge is rotated out of the receiving space, and that, conversely, in the case of a counterclockwise rotation of the item of food, the second cutting edge automatically rotates into the receiving space, while the first cutting edge is rotated out of the receiving space.

It can advantageously also be provided in particular that the chopping tool has a pendulum blade with two cutting edges, of which, in particular automatically, in each case one cuts into the item of food in a manner dependent on the direction of rotation of the item of food to be chopped.

In a particular embodiment, the chopping tool is designed to simultaneously sever a plurality of spiral ribbons from an item of food. In this manner, it is possible for vegetables to be advantageously cut into vegetable spaghetti for example zucchini spaghetti. The chopping tool can in particular have a cutting unit which splits the layer to be severed, or the layer that has already been severed, into a plurality of mutually parallel strips. Alternatively or in addition, it can also be provided that the chopping tool has a cutting blade which severs a layer from the item for cutting, and a cutting unit which has further cutting blades arranged perpendicular to the cutting blade. The further cutting blades can serve for splitting the layer to be severed, or the layer which has already been severed, into a plurality of mutually parallel strips.

The device for chopping food can have precisely one chopping tool in the manner of a sharpener. However, it is by all means advantageously possible for the device to have a further chopping tool in the manner of a sharpener or a plurality of further chopping tools each in the manner of a sharpener. In particular, it can advantageously be provided that the further chopping tool has a different size than the chopping tool, and/or that the receiving space of the further chopping tool has a different wedge angle than the receiving space of the chopping tool. It is thereby made possible to selectively cut spiral ribbons of different shape. It is also possible to use a smaller one of the chopping tools in the case of an item of food of small diameter, and to use a larger one of the chopping tools in the case of an item of food of relatively large diameter.

In an advantageous manner, the device can be designed as a cover which is formed on a vessel, in particular a vessel for the chopped item of food and/or for the item of food cut into spiral ribbons. In particular, the device can be designed as a cover which is placeable onto a vessel and/or is fixable to a vessel. An embodiment in which the device is designed as a cover which is placeable onto a vessel and/or is fixable to a vessel, in a manner completely covering the vessel opening, is particularly advantageous.

For example, the item of food which is chopped by being pushed through the cutting part can thereby be securely and reliably collected in the vessel. It is also possible for the item of food cut into spiral ribbons to be collected, in particular automatically, in the vessel.

In a particular embodiment, the vessel is designed as a stand for placing the chopping device on a work surface.

As an alternative to a design of the device as a cover for a vessel, it can advantageously also be provided that the base part and/or the further base part has a vessel, in particular a vessel for the chopped item of food, and/or for the item of food cut into spiral ribbons.

A kitchen appliance which has a vessel for collecting the chopped item of food, and a device according to the invention for chopping food, which device is placed and/or is placeable onto the vessel, in particular in a manner completely covering the vessel opening, is very particularly advantageous. In this connection, it can in particular be advantageously provided that the device can be fixed to the vessel in a manner releasable again, in particular without a tool.

In an advantageous manner, it can be provided that the kitchen appliance is designed and intended to be placed on a work surface for a chopping operation. Such an embodiment has the particular advantage that the user can concentrate solely on the chopping operation without having to hold the device as a whole in mid-air.

A food chopping system which has a device according to the invention and in addition a holding part with a discharge opening and with a cutting insert receptacle, in which one of the cutting inserts is selectively fixable, in particular in a manner releasable again without a tool, is of very particular advantage. It should be pointed out for the sake of clarity that the holding part is not the holding plate which has already been mentioned further above and is in particular insertable into the receptacle. On the contrary, the holding part serves to be able to selectively use one of the cutting inserts in each case independently of the base part, the actuating part and the holding plate, this being described in detail below.

Such a food chopping system has the very particular advantage that the user can firstly use the cutting inserts in the manner described above, with the use of the holding plate, and additionally has the possibility of using the cutting inserts with a separate holding part independently of the base part. This makes it in particular also possible for one user to chop food by the user pushing said food through the cutting part by means of the actuating part while another user simultaneously cuts other food into spiral ribbons with the aid of a cutting insert inserted into the holding part. It is also possible for two users to simultaneously cut spiral ribbons—one user using the holding plate which is inserted into the receptacle and into which a cutting insert is fitted, and the other user using the holding part into which another cutting insert is fitted.

In particular, it can be advantageously provided that the cutting insert is fixable in the cutting insert receptacle, in particular in the manner releasable again without a tool, in a latching manner and/or with a quarter turn connection. This preferably involves the same type of latching connection or quarter turn connection which the holding plate also has, and therefore the cutting inserts can be fixed both to the holding plate and to the holding part without additional adapters being required.

In a very particularly advantageous manner, the holding part can be designed to be held during its use exclusively in one hand, and therefore the user can rotate the item for cutting relative to the cutting insert, which is inserted into the cutting insert receptacle, with the other hand. In particular for this purpose, the holding part can advantageously have a handle portion.

In a particularly advantageous embodiment, the holding part is of circular-cylindrical and/or elongate design. Such an embodiment has the particular advantage that the user can simply and reliably grasp the holding part and can securely hold the latter during the cutting operation. The diameter of the holding part can advantageously lie within the range of 5 cm to 9 cm, in particular within the range of 6 cm to 8 cm, or very particularly can be 7.5 cm.

An embodiment in which the cutting insert receptacle and the discharge opening are arranged at opposite ends of the holding part can be handled particularly ergonomically. In particular, the holding part can be of tubular design, wherein one tube opening forms the discharge opening while the other tube opening forms the inlet to the cutting insert receptacle.

In a particularly advantageous embodiment, the food chopping system has a holder for the item for cutting. The holder for the item for cutting is designed to be brought into connection for conjoint rotation with the item of food to be cut. For this purpose, the holder for the item for cutting can have, for example, a multiplicity of spikes which are pushed into the item of food.

The holder for the item for cutting can advantageously be of substantially disc-shaped, in particular circular-disc-shaped design. In the case of a disc-shaped design, the spikes can be arranged protruding, in particular perpendicularly, from the circular disc. The use of a holder for the item for cutting has the particular advantage that the user has the item for cutting better under control. This in particular if the item for cutting is moist or has a small diameter or when it is difficult to grasp with the hand for other reasons. The holder of the item for cutting can advantageously have a diameter which is greater than the diameter of the receiving space of the cutting inserts to be used. The effect advantageously achieved by this is that, because of the large lever, the user can exert a particularly large torque on the item of food to be cut. This in particular if the item of food itself has a small diameter.

In a particularly advantageous embodiment, the holder for the item for cutting is designed as a cover for the discharge opening. In particular, it can advantageously be provided that the holder for the item for cutting is fixable to the holding part, in particular in a manner releasable again without a tool, by means of a latching connection or by means of a quarter turn connection. It can be provided in particular in this connection that the holder for the item of cutting, which is designed as a cover, completely covers the discharge opening when said holder is fixed to the holding part.

In a particular embodiment, the holding part has, in the region of the discharge opening, an external thread which is intended to interact with an internal thread of the holder for the item for cutting, which is usable as a cover.

In an analogous manner, the holding part can also have, in the region of the cutting insert receptacle, an external thread which interacts with an internal thread of the cutting insert in order to be able to fix the cutting insert in the cutting insert receptacle, in particular in a manner releasable again without a tool.

In a very particularly advantageous embodiment, the holding part has two identical openings which are designed in such a manner that each of the openings can act either as a discharge opening or as an opening for the introduction of a cutting part. In such an embodiment, it can advantageously also be provided that the holding part has identical external threads in the region of the openings, and therefore a cutting insert or the holder for the item for cutting can be fixed in the region of each of the openings.

Of course, it is alternatively also possible for the holding part to have an internal thread for fixing the cutting insert and/or the holder for the item for cutting, while the cutting insert and/or the holder for the item for cutting have/has an external thread.

Instead of a threaded connection, in particular in the manner of a quarter turn fastening, a latching connection and/or a plug-in connection can alternatively or additionally also be provided.

### BRIEF DESCRIPTION OF THE DRAWING VIEWS

The drawing illustrates the subject matter of the invention by way of example and schematically and is described below with reference to the figures, wherein elements which are identical or have an identical effect are generally provided with the same reference signs. In the figures:

FIG. 1 shows an exemplary embodiment of a device according to the invention for chopping food,

FIG. 2 shows the device converted for cutting spiral ribbons,

FIG. 3 shows another exemplary embodiment of a device according to the invention for chopping food,

FIG. 4 shows another exemplary embodiment with the actuating part open,

FIG. 5 shows a further exemplary embodiment of a device according to the invention for chopping food,

FIG. 6 shows a detailed view of a fourth exemplary embodiment of a device according to the invention for chopping food,

FIG. 7 shows the detail illustrated in FIG. 6 in an exploded illustration,

FIG. 8 shows a detailed view of a fifth exemplary embodiment of a device according to the invention for chopping food,

FIG. 9 shows a first exemplary embodiment of a cutting insert,

FIG. 10 shows the first exemplary embodiment of a cutting insert in a side view,

FIG. 11 shows the first exemplary embodiment of a cutting insert in a perspective illustration,

FIG. 12 shows a second exemplary embodiment of a cutting insert in a perspective illustration,

FIG. 13 shows a third exemplary embodiment of a cutting insert in a perspective illustration,

FIG. 14 shows a fourth exemplary embodiment of a cutting insert in a perspective illustration,

FIG. 15 shows a detailed view of a food chopping system according to the invention, and

FIG. 16 shows a further detailed view of a food chopping system according to the invention.

### DETAILED DESCRIPTION OF THE INVENTION

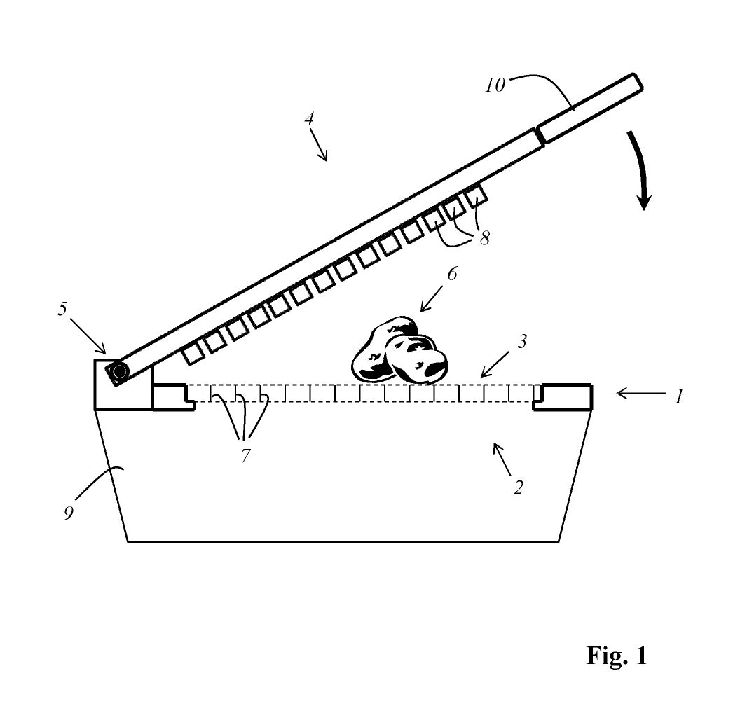

FIG. 1 shows an exemplary embodiment of a device according to the invention for chopping food, during a chopping operation. The device has a base part 1 which has a receptacle 2 for a cutting part 3. The base part 1 is connected in an articulated manner to an actuating part 4 by means of a hinge connection 5 such that the actuating part 4 can be pivoted toward the cutting part 3 in order to push through an item 6 to be chopped. The cutting part 3 has a plurality of cutting part blades 7, between which the pressing plungers 8 of the actuating part 4 protrude during the chopping operation. A handle 10 is arranged at the free end of the actuating part 4. The base part 1 is placed onto a vessel 9, in a manner completely covering the vessel opening, and is fixed there, in a manner releasable again without a tool.

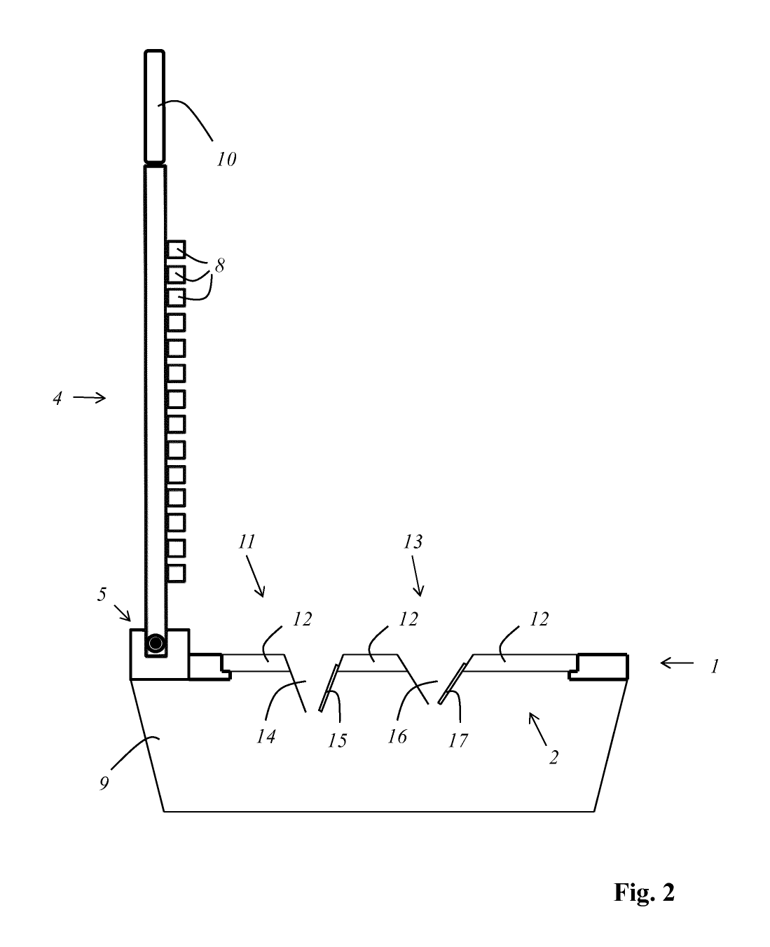

FIG. 2 shows the device converted for cutting spiral ribbons. For the conversion, the cutting part 3 has been removed from the receptacle 2 and instead a chopping tool 11 in the manner of a sharpener has been fitted into the receptacle 2. The chopping tool 11 has a holding plate 12 which, in terms of shape and size, has the same outer contour as the cutting part 3. This makes it possible to temporarily fix the chopping tool instead of the cutting part 3 in the receptacle 2 of the base part 1 without additional fixing components being required. In addition, a further chopping tool 13 is also held in the holding plate 12 of the chopping tool 11.

The chopping tool 11 has a conical receiving space 14 for the introduction of an item of food, such as, for example, a carrot, a radish or a cucumber, on the wall of which receiving space a cutting blade 15 is arranged. By rotation of the item of food introduced into the receiving space 14, the tip of said item of food enters into operative connection with the cutting blade 15, as a result of which a spiral ribbon (not illustrated) is severed by cutting. In addition, the wall of the receiving space 14 has an opening (not illustrated) through which the spiral ribbon can pass out of the receiving space 14. The spiral ribbon is automatically collected in the vessel 9.

The further chopping tool 13 in the manner of a sharpener has a different size than the chopping tool 11. In addition, the further receiving space 16 of the further chopping tool 13 has a different wedge angle than the receiving space 14 of the chopping tool 11. A further cutting blade 17 is arranged on the wall of the further receiving space 16, said cutting blade projecting into the further receiving space 16 and severing a spiral ribbon (not illustrated) from an item of food which is rotated in the further receiving space about the center axis of rotation of the further receiving space 16. The wall of the further receiving space 16 also has an opening through which the spiral ribbon severed there can pass out of the further receiving space 16 and thus enter the vessel 9.

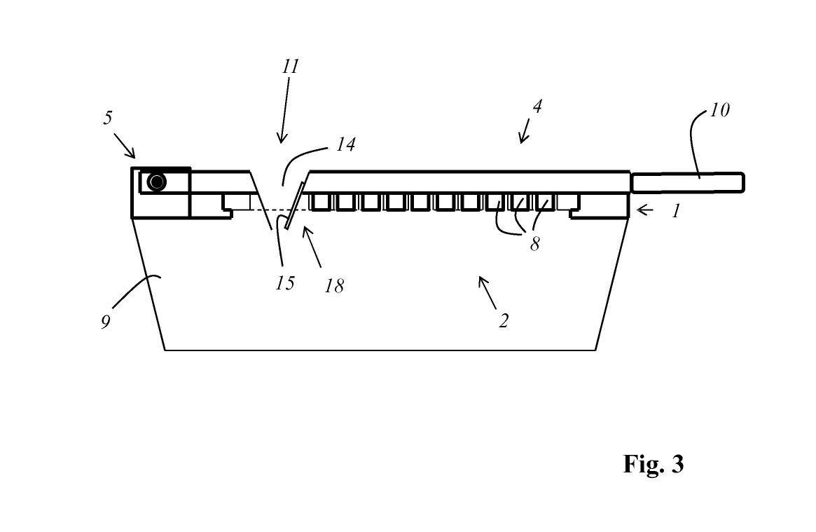

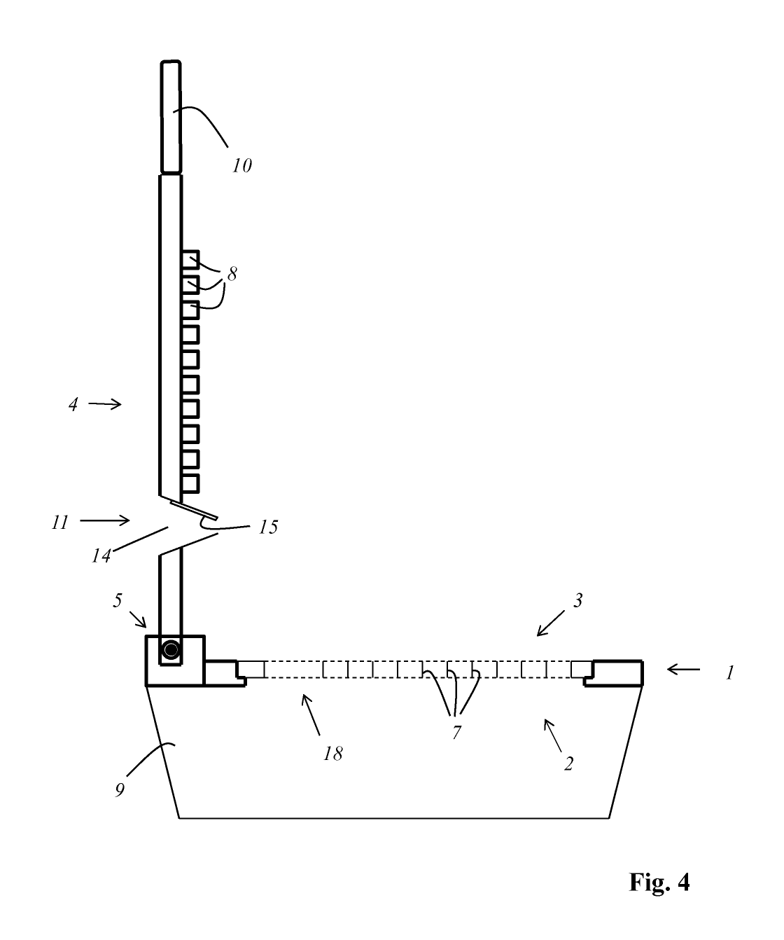

FIGS. 3 and 4 show another exemplary embodiment of a device according to the invention for chopping food. In this embodiment, the chopping tool 11 in the manner of a sharpener is arranged in the actuating part 4.

The actuating part 4 has a first portion with pressing plungers 8 which serve for pushing an item of food to be chopped through a cutting part 3, which is provided with cutting part blades 7, by the actuating part 4 being pivoted toward the cutting part 3. The chopping tool 11 is arranged in a second portion of the actuating part 4.

In this exemplary embodiment, the cutting part 3 has a passage opening 18 which is free from cutting part blades. When the actuating part 4 is closed, a part of the chopping tool 11 projects through the passage opening 18. In addition, the spiral ribbon which has been severed (not illustrated) can pass through the passage opening 18 into the vessel 9.

The chopping tool 11 has a conical receiving space 14 for the introduction of an item of food, such as, for example, a carrot, a radish or a cucumber, on the wall of which receiving space a cutting blade 15 is arranged. By rotation of the item of food which has been introduced into the receiving space, the tip of said item of food enters into operative connection with the cutting blade 15, as a result of which the spiral ribbon (not illustrated) is severed by cutting. In addition, the wall of the receiving space 14 has an opening (not illustrated) through which the spiral ribbon can pass out of the receiving space 14.

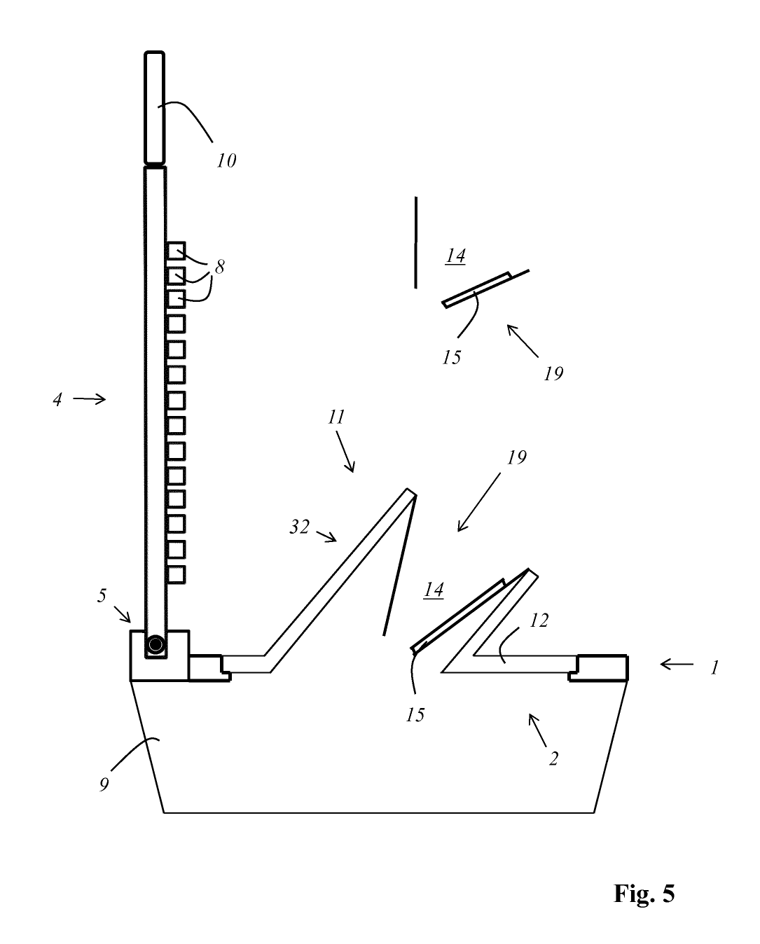

FIG. 5 shows a further exemplary embodiment of a device according to the invention. In this exemplary embodiment, the chopping tool 11 has a holding plate 12 into which at least one of a plurality of different cutting inserts 19 is selectively fittable. The cutting inserts 19 each have a conical receiving space 14 for the introduction of an item of food, on the wall of which receiving space a cutting blade 15 is in each case arranged and in which receiving space the item of food is rotatable. The cutting inserts 19 can differ in particular in terms of their shape and/or size and/or in terms of the thickness and/or width of the spiral ribbons cuttable therewith and/or in terms of the number of spiral ribbons produced simultaneously during a cutting operation.

The cutting insert inserted in each case into the holding plate 12 can be fixed in a manner releasable again, in particular without a tool, for example by means of a latching unit or a quarter turn fastening.

The holding plate 12 has, in terms of shape and size, the same outer contour as a cutting part 3 which is insertable into the receptacle. This makes it possible for the chopping tool 11 to be temporarily fixed, instead of a cutting part 3, in the receptacle 2 of the base part 1 without additional fixing components being required. Furthermore, the holding plate has a cylindrical projection 32 into which one cutting insert 33 is in each case fittable.

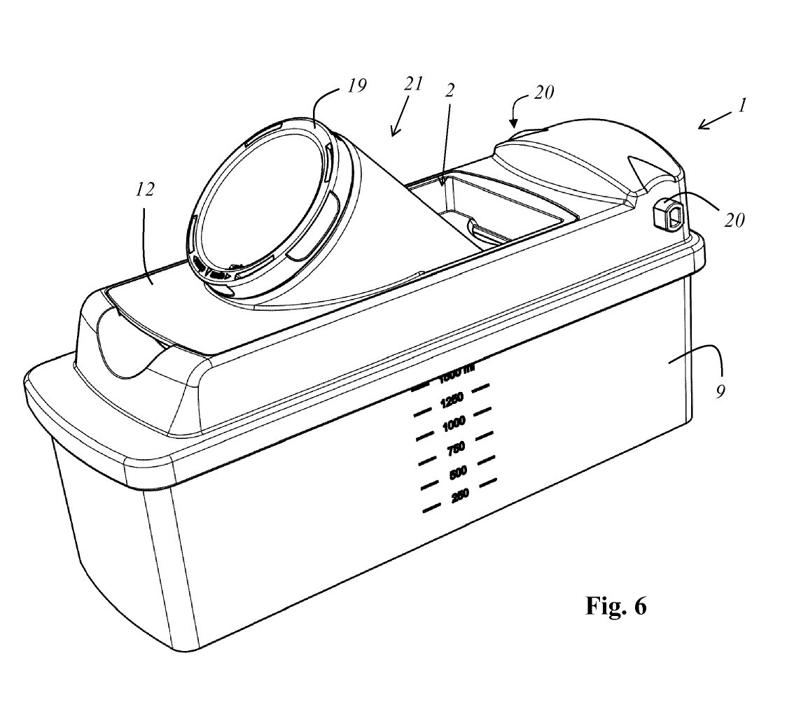

FIG. 6 shows a detailed view of a fourth exemplary embodiment of a device according to the invention. Since the actuating part 4 is not required for cutting the item of food into spiral ribbons, said actuating part has been temporarily removed from the base part 1. The articulated connection is designed to be releasable so that the actuating part 4 can be removed. Of the articulated connection 5, only the bearing pins 20 can be seen in FIG. 6, said bearing pins being pushed radially into joint receptacles of the actuating part 4 in order to produce the articulated connection 5 to the actuating part 4.

The base part 1 has a receptacle 2 into which a holding plate 1 is inserted. The holding plate 12 has a cylinder-tube-shaped projection 21 into which a cutting insert 19 is inserted. As is also explained further below in detail, it is possible to selectively fit one of a plurality of different cutting inserts 19 into the holding plate 12. The user therefore has the possibility of cutting spiral ribbons of different widths and/or different thicknesses and/or of selecting the cutting insert in accordance with the size or the composition of the item of food to be cut.

It is also possible in this embodiment to remove the holding plate 12 from the receptacle 2 and instead to insert a cutting part 3 in order to be able to push an item of food to be chopped through the cutting part 3 with the aid of the actuating part 4.

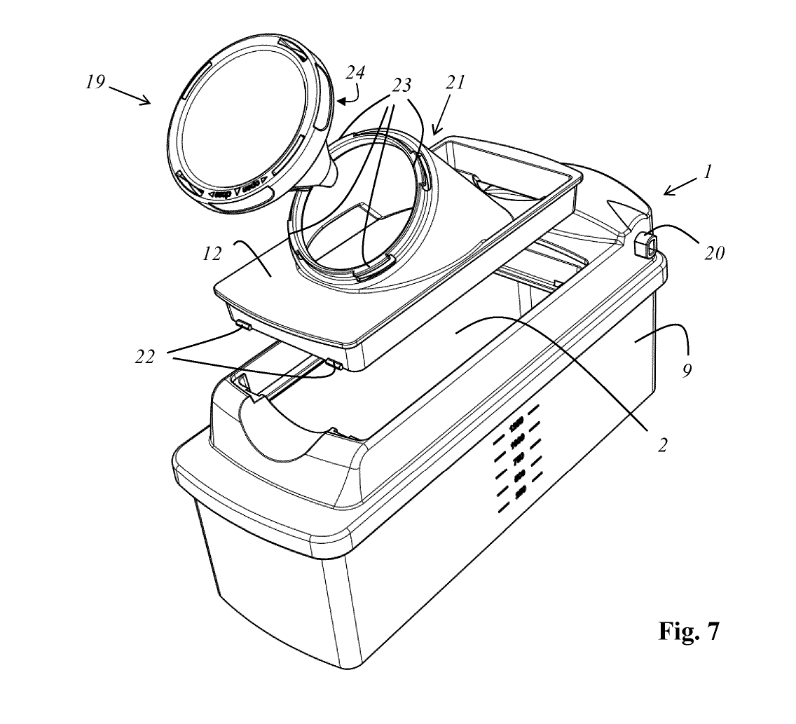

FIG. 7 shows the detail, which is illustrated in FIG. 6, of the device according to the invention in an exploded illustration. It can be seen that the holding plate 12 has a plurality of latching lugs 22 which securely fix the holding plate 12 in the receptacle 2 and which are nevertheless designed in such a manner that the holding plate 12 can be removed again from the receptacle 2 without a tool.

The cylindrical projection 21 has a quarter-turn-like external thread 23 which is intended to interact with an internal thread 24 of the cutting insert 19. This makes it possible to be able to fix the cutting insert 19 rapidly and securely to the holding plate 12 and, after use, to be able to remove it again simply and without a tool.

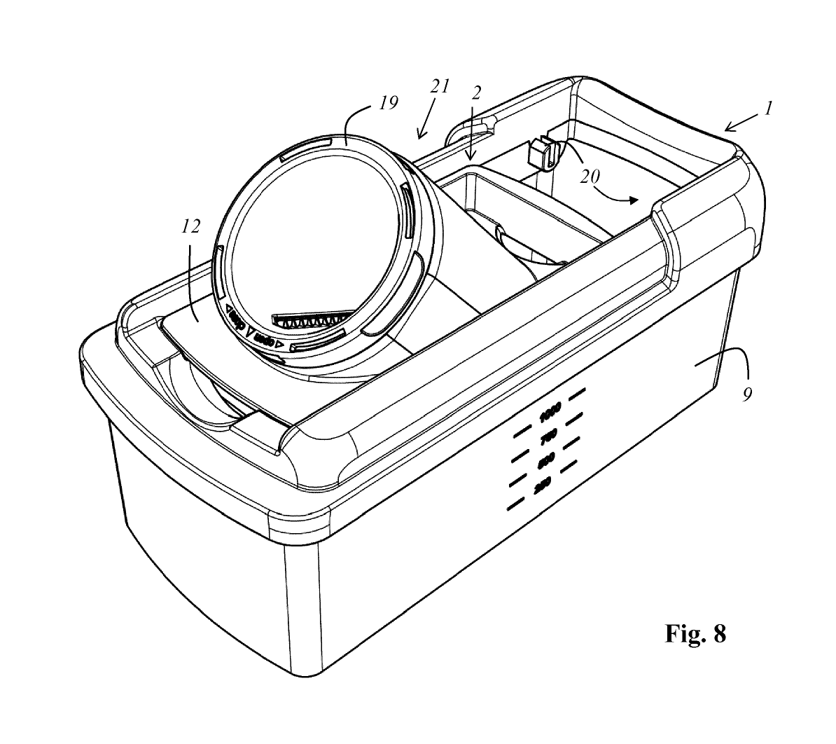

FIG. 8 shows a detailed view of a fifth exemplary embodiment of a device according to the invention. This embodiment differs from the embodiment shown in FIGS. 6 and 7 in particular in that the bearing pins 20 of the pivot mounting 5 are arranged in the opening of the base part 1.

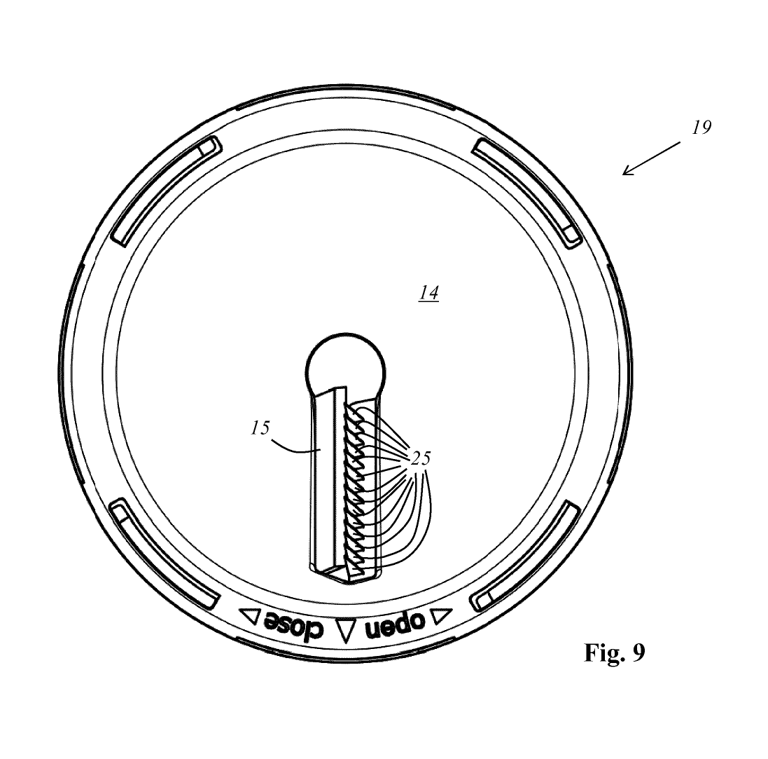

FIG. 9 shows a first exemplary embodiment of a cutting insert 9 in top view in the axial direction. The cutting insert 19 has a conical receiving space 14 into which an item of food, such as, for example, the tip of a cucumber, a carrot or a radish, can be introduced. A cutting blade 15 projects into the receiving space 14, said cutting blade simultaneously severing a plurality of spiral ribbons in a cutting manner from the item of food rotating in the receiving space 14. The simultaneous severing of a plurality of spiral ribbons is achieved by the fact that the cutting insert 19 has further cutting blades 25 which likewise project into the receiving space 14 and which are arranged perpendicular to the cutting blade 15. Said further cutting blades 25 act as a julienne cutter which cuts the layer to be severed by means of the cutting blade 15 into a plurality of strips.

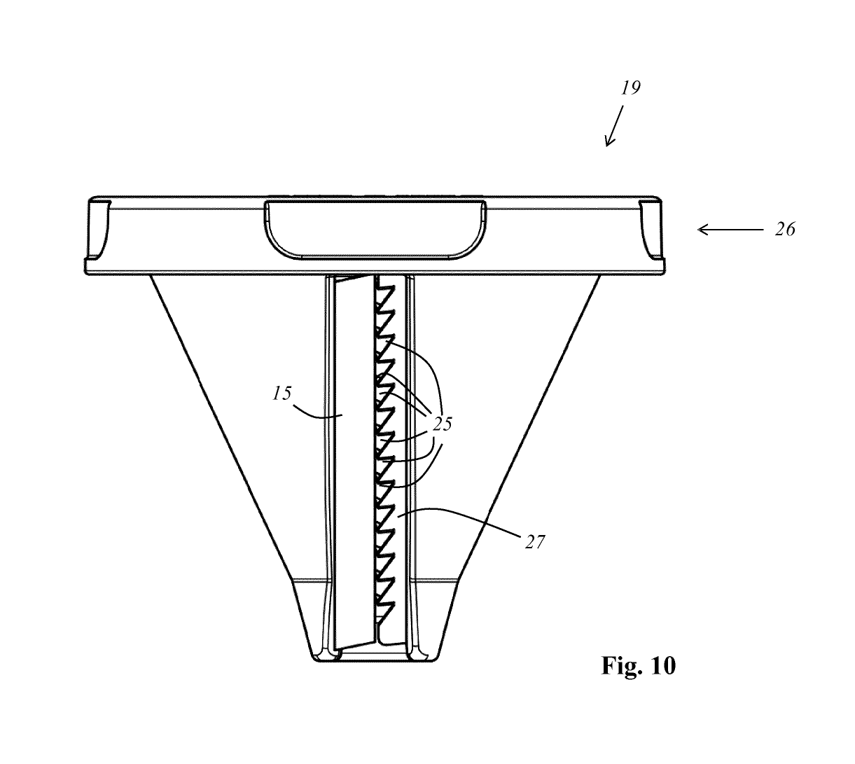

FIG. 10 shows the cutting insert 19, which has already been illustrated in FIG. 9, in a side view. It can be seen that the cutting insert 19 has a handle portion 26 at which the cutting insert 19 can be held for insertion into the holding plate 12 or into a cutting part receptacle of a holding part and rotated (if required for fastening). After the cutting part is inserted, the latter is held in the holding part preferably for conjoint rotation. The cutting insert 19 has, in the region of the cutting blade 15 and the further cutting blades 25, a slot opening 27 through which the spiral ribbons can pass out of the receiving space 14.

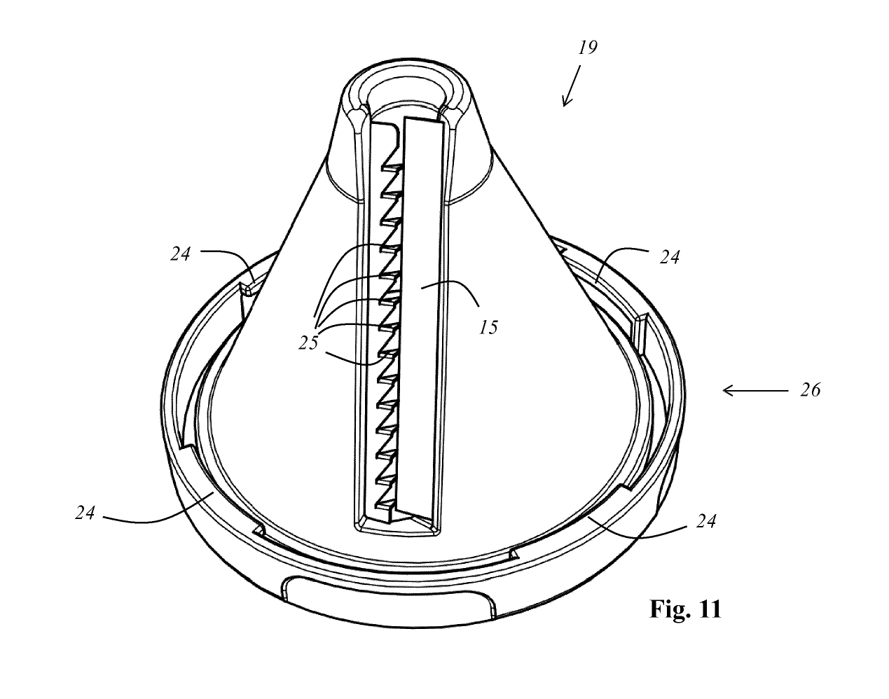

FIG. 11 shows the cutting insert 19, which has already been illustrated in FIGS. 9 and 10, in a perspective illustration. The cutting insert 19 has, in the region of its handle portion 26, an encircling collar with a quarter-turn-like internal thread 24 which is intended to interact with the external thread 23 of the holding plate 12 or with a corresponding external thread 23 of a holding part.

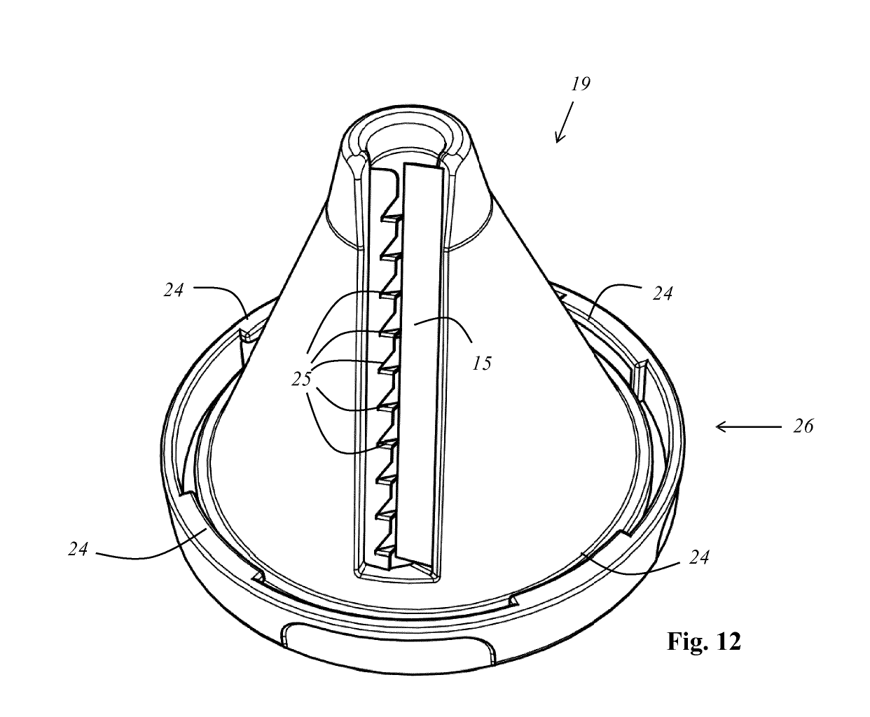

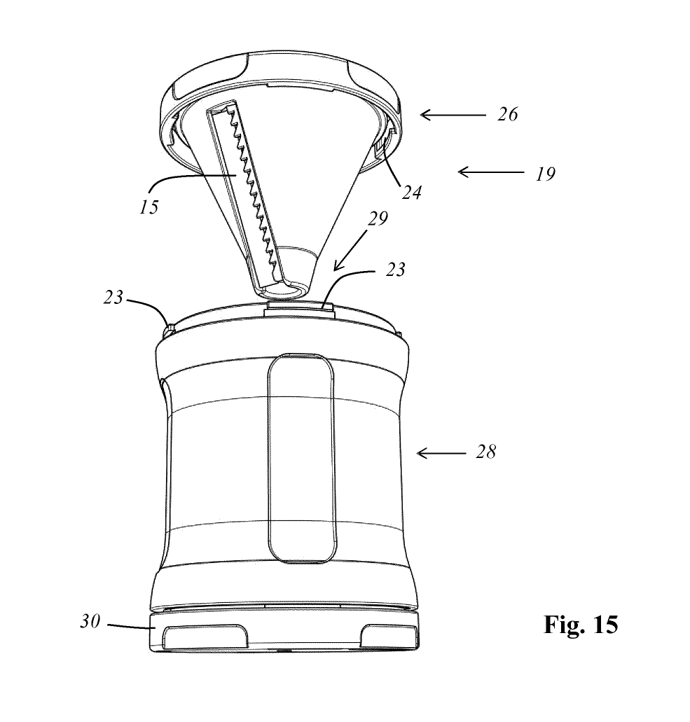

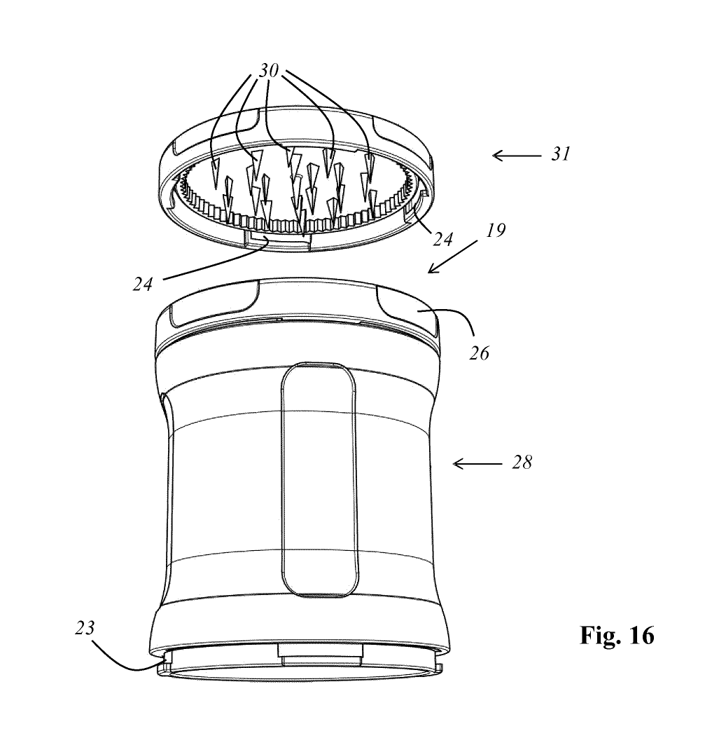

FIG. 12 shows a second exemplary embodiment of a cutting insert 19 which differs from the exemplary embodiment illustrated in FIGS. 9 to 11 in that the spacing of the further cutting blades 25 from one another is greater, and therefore wider spiral ribbons arise when this cutting insert 3 is used. With regard to the handle part 26 and with regard to the quarter-turn-like internal thread 24, the cutting insert 3 shown in FIG. 12 is constructed identically to the cutting insert shown in FIGS. 9 to 11, which ensures that the user can fix, and release again, the different cutting inserts 19 to/from the holding plate 12 or to/from the holding part 28, which is also described in detail with reference to FIGS. 15 and 16, in an identical manner.

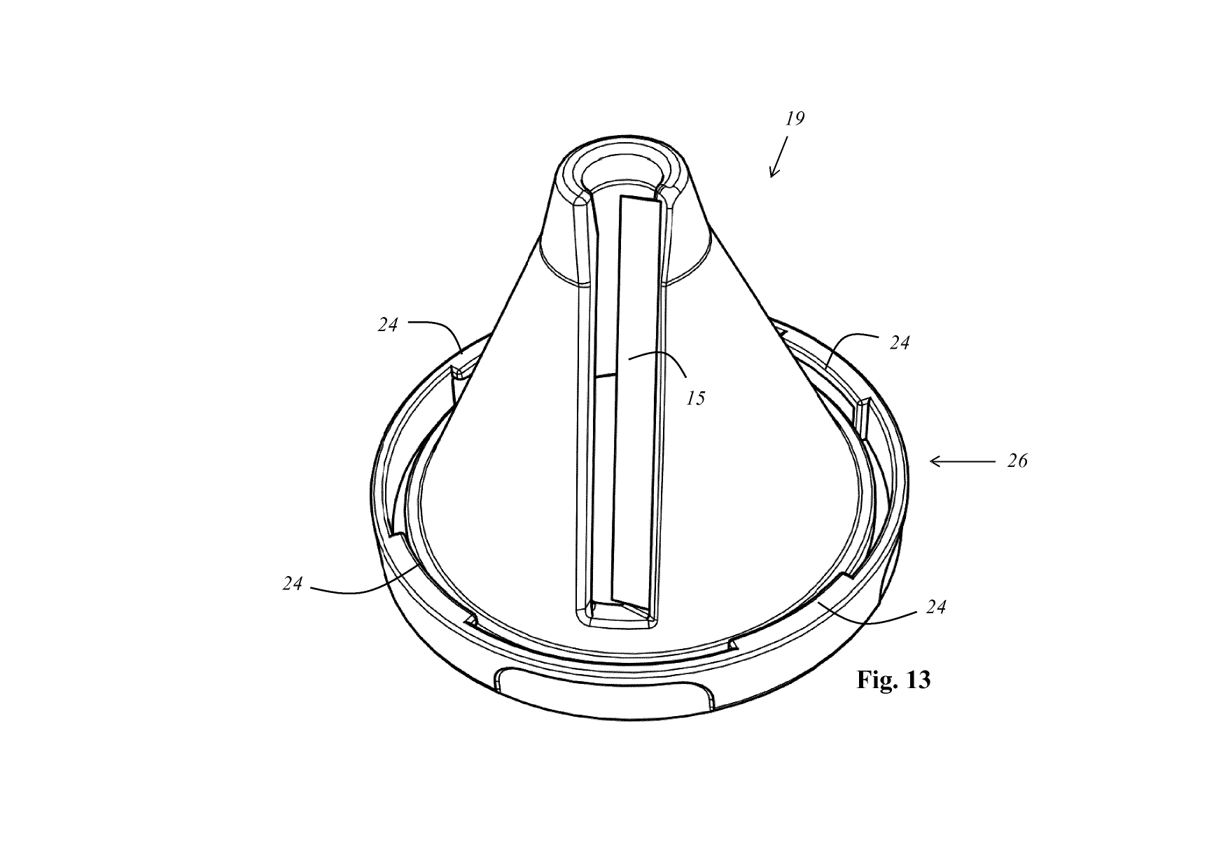

FIG. 13 shows a third exemplary embodiment of a cutting insert 19 which does not have any further cutting blades 25. When said third exemplary embodiment of a cutting insert 19 is used, particularly wide spiral ribbons are cut.

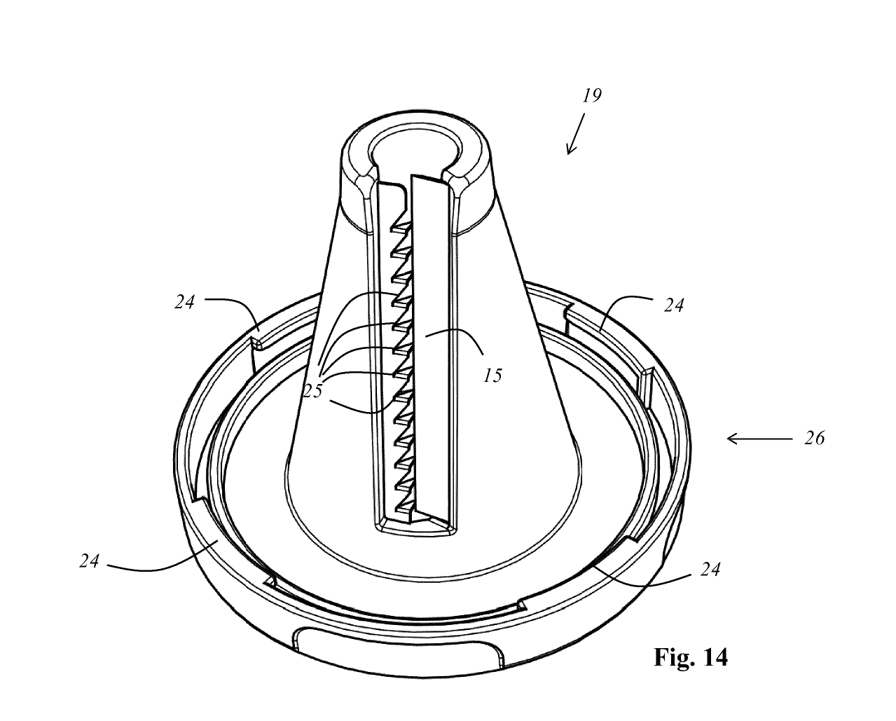

FIG. 14 shows a fourth exemplary embodiment of a cutting insert 19 which has a receiving space 14 with a smaller inlet diameter and a reduced angle of taper. This cutting insert 19 can be used in particular to simultaneously sever a multiplicity of spiral ribbons from food of thin diameter.

FIG. 15 shows a detailed view of a food chopping system according to the invention. The food chopping system has a holding part 28 which provides a cutting insert receptacle 29. A cutting insert 19, as illustrated for example in FIGS. 9 to 14, can be inserted into the cutting insert receptacle 29. For this purpose, the holding part 28, which is of substantially circular-cylindrical construction, has, on the end side, an external thread 23 which can interact with an internal thread 24 of one of the cutting inserts 19. The user can freely decide which of a plurality of cutting inserts 19 he/she would like to use and therefore has the possibility of cutting spiral ribbons of different width and/or different thickness and/or of selecting the cutting insert 19 in accordance with the size or the composition of the item of food to be cut.

At the end opposite the cutting insert receptacle 29, the holding part 28 has a discharge opening which can be closed by means of a holder for the item for cutting 31, which is additionally also designed as a cover for the discharge opening.

As FIG. 16 shows, the holding part 28 also has, in the region of its discharge opening, an external thread 23 which interacts with a quarter-turn-like internal thread of the holder for the item for cutting 31 when the holder for the item for cutting 31 is placed onto the discharge opening.

The possibility of being able to fasten the holder for the item for cutting 31 at the discharge opening has the very particular advantage that the holder for the item for cutting 31 can be stored directly on the holding part 28 and cannot be inadvertently lost during storage of the food chopping system.

The holder for the item for cutting 31 has vertically protruding spikes 30 which are intended to be pierced axially into the item of food to be processed, and therefore the item of food can be rotated in a secure and reliable manner in the receiving space 14 of the cutting insert 19 with the aid of the holder for the item for cutting 31.

### LIST OF REFERENCE SIGNS

1 Base part
2 Receptacle
3 Cutting part
4 Actuating part
5 Hinge connection
6 Item of food to be chopped
7 Cutting part blades
8 Pressing plunger
9 Vessel
10 Handle
11 Chopping tool
12 Holding plate
13 Further chopping tool
14 Receiving space
15 Cutting blade
16 Further receiving space
17 Further cutting blade
18 Passage opening
19 Cutting insert
20 Joint head
21 Cylindrical projection
22 Latching lugs
23 External thread
24 Internal thread
25 Further cutting blades
26 Handle portion
27 Slot opening
28 Holding part
29 Cutting insert receptacle
30 Spikes
31 Holder for the item for cutting
32 Cylindrical projection

What is claimed is:

1. A device for chopping food, having a base part which has a receptacle for a cutting part, and having an actuating part which is fixable to the base part in an articulated manner such that the actuating part is pivotable toward the cutting part in order to push through an item to be chopped, characterized in that the device has at least one chopping tool in the manner of a sharpener, wherein the chopping tool is insertable into the receptacle, or wherein there is a further base part which has the chopping tool and which is connectable instead of the base part to the actuating part in an articulated manner, or wherein the actuating part has the chopping tool.

2. The device as claimed in claim 1, characterized in that
a. the chopping tool is insertable instead of the cutting part into the receptacle, and/or
b. the chopping tool is insertable in an accurately fitting manner into the receptacle, and/or
c. the chopping tool is insertable with the frame in a latching manner into the receptacle.

3. The device as claimed in claim 1, characterized in that
a. the chopping tool has a holding plate which, in terms of shape and size, has the same outer contour as the cutting part, and/or in that
b. the chopping tool has a holding plate into which at least one of a plurality of different cutting inserts is selectively fittable, and/or in that
c. the chopping tool has a holding plate into which at least one of a plurality of different cutting inserts is selectively fittable, wherein each cutting insert has an, in particular conical, receiving space for the introduction of an item of food, on the wall of which receiving space a cutting blade is arranged, and/or in that
d. the chopping tool has a holding plate into which at least one of a plurality of different cutting inserts is selectively fittable, wherein each cutting insert has an, in particular conical, receiving space for the introduction of an item of food, in which receiving space the item of food is rotatable.

4. The device as claimed in claim 1, characterized by an insert which is insertable, in particular in an accurately fitting and/or latching manner, into the receptacle and has both the cutting part and the chopping tool.

5. (canceled)

6. (canceled)

7. The device as claimed in claim 1, characterized in that
a. the chopping tool has an, in particular conical, receiving space for the introduction of an item of food, on the wall of which receiving space a cutting blade is arranged, and/or in that
b. the chopping tool has an, in particular conical, receiving space for the introduction of an item of food, in which receiving space the item of food is rotatable.

8. The device as claimed in claim 7, characterized in that a cutting edge of the cutting blade projects into the receiving space, and/or in that the cutting blade is arranged in such a manner that it severs a layer from an item of food rotating in the receiving space.

9. The device as claimed in claim 7, characterized in that the chopping tool severs a layer of a first thickness from an item of food rotating in the clockwise direction in the receiving space, and in that the chopping tool severs a layer of a second thickness, which is different from the first thickness, from an item of food rotating counterclockwise in the receiving space.

10. The device as claimed in claim 1, characterized in that
a. the chopping tool has a pendulum blade with two cutting edges, and/or in that
b. the chopping tool has a pendulum blade with two cutting edges for different cutting thicknesses, and/or in that
c. the chopping tool has a pendulum blade with two cutting edges, of which, in particular automatically, in each case one cuts into the item of food in a manner dependent on the direction of rotation of the item of food to be chopped.

11. The device as claimed in claim 1, characterized in that
a. the chopping tool is designed to simultaneously sever a plurality of spiral ribbons from an item of food, and/or in that
b. the chopping tool has a cutting unit which splits the layer to be severed, or the layer that has already been severed, into a plurality of mutually parallel strips, and/or in that
c. the chopping tool has a cutting blade which severs a layer from the item for cutting, and a cutting unit which has further cutting blades arranged perpendicular to the cutting blade.

12. The device as claimed in claim 1, characterized in that the device has at least one further chopping tool characterized in that
a. the further chopping tool is insertable instead of the cutting part into the receptacle, and/or
b. the further chopping tool is insertable in an accurately fitting manner into the receptacle, and/or
c. the further chopping tool is insertable with the frame in a latching manner into the receptacle.

13. The device as claimed in claim 12, characterized in that the further chopping tool has a different size than the chopping tool, and/or in that the receiving space of the further chopping tool has a different angle of taper than the receiving space of the chopping tool.

14. The device as claimed in claim 1, characterized in that
a. the device is designed as a cover for a vessel, in particular a vessel for the chopped item of food, and/or in that
b. the device is designed as a cover which is placeable onto a vessel, in particular a vessel for the chopped item of food, and/or is fixable to a vessel, and/or in that
c. the device is designed as a cover which is placeable onto a vessel, in particular a vessel for the chopped item of food, in a manner completely covering the vessel opening, and/or is fixable to a vessel.

15. The device as claimed in claim 1, characterized in that the base part is designed as a vessel, in particular as a vessel for the chopped item of food, and/or has a vessel, in particular a vessel for the chopped item of food.

16. A kitchen appliance having a device as claimed in claim 1, which device is designed as a cover, and having a vessel onto which the device is placed, preferably in a manner completely covering the vessel opening, and/or to which the device is fixed, preferably in a manner releasable again without a tool.

17. The kitchen appliance as claimed in claim 16, characterized in that the kitchen appliance is designed and intended to be placed on a work surface for a chopping operation.

18. A chopping tool in the manner of a sharpener, in particular for food, characterized in that layers of different thickness can be severed in a manner depending on the direction of rotation.

19. The chopping tool as claimed in claim 18, characterized by
a. a pendulum blade which has two cutting edges, and/or by
b. a pendulum blade with two cutting edges, wherein one cutting edge serves for cutting into thin spiral ribbons, while the other cutting edge serves for cutting into thick spiral ribbons, and/or by
c. a pendulum blade with two cutting edges, of which, in particular automatically, in each case one cuts into the item of food in a manner dependent on the direction of rotation of the item of food to be chopped.

20. A food chopping system comprising a device as claimed in claim 3 and comprising a holding part with a discharge opening and with a cutting insert receptacle in which one of the cutting inserts is selectively fixable, in particular in a manner releasable again without a tool.

21. The food chopping system as claimed in claim 20, characterized in that
a. the holding part has a handle portion, and/or in that
b. the holding part is designed to be in a hand, in particular exclusively one hand, and/or in that
c. the holding part is designed to be held during its use exclusively in one hand in such a manner that the user can rotate the item for cutting relative to the cutting insert with their other hand.

22. The food chopping system as claimed in claim 20, characterized in that
a. the holding part is of circular-cylindrical design, and/or in that
b. the holding part is of elongate design, and/or in that
c. the holding part is of tubular design, and/or in that
d. the cutting insert receptacle and the discharge opening are arranged at opposite ends of the holding part.

23. The food chopping system as claimed in claim 20, characterized by a holder for the item for cutting.

24. The food chopping system as claimed in claim 23, characterized in that the holder for the item for cutting is of substantially disc-shaped, in particular circular-disc-shaped, design, and/or in that the holder for the item for cutting has holding spikes.

25. The food chopping system as claimed in claim 23, characterized in that
a. the holder for the item for cutting is designed as a cover for the discharge opening, and/or in that
b. the holder for the item for cutting is fixable to the holding part, in particular in a manner releasable again without a tool, by means of a latching connection or by means of a quarter turn connection or a plug-in connection, and/or in that
c. the holder for the item for cutting is fixable to the holding part, in particular in a manner releasable again without a tool, by means of a latching connection or by means of a quarter turn connection or a plug-in connection, in a manner completely covering the discharge opening.

26. A cutting insert for a device as claimed in claim 3.
